(19) United States
(12) Patent Application Publication
(10) Pub. No.: US 2011/0273702 A1
(43) Pub. Date: Nov. 10, 2011

(54) OPTICAL MEASURING METHOD AND SYSTEM

(75) Inventors: Nicholas H. H. Jones, Stroud (GB); Nicholas J. Weston, Peebles (GB); Kevyn B. Jonas, Bristol (GB); Jonathan D. Shephard, Edinburgh (GB); Duncan P. Hand, Edinburgh (GB); Mateusz Matysiak, Edinburgh (GB)

(73) Assignee: RENISHAW PLC, Wotton-Under-Edge, Gloucestershire (GB)

(21) Appl. No.: 13/145,194

(22) PCT Filed: Jan. 20, 2010
(86) PCT No.: PCT/GB2010/000088

§ 371 Date: Jul. 19, 2011

(30) Foreign Application Priority Data
Jan. 22, 2009 (GB) 0901040.6

(51) Int. Cl. G01J 3/30; G01N 21/88; G01N 21/27

(52) U.S. Cl. 356/51; 356/237.1

(57) ABSTRACT

A detecting system for detecting flaws in a sample includes an illumination assembly and detecting assembly. The illumination assembly has an infra-red light source and illumination optics for directing a beam of light from the light source to a spot on or within a sample. The detection assembly has a detector for detecting light from an illuminated spot on or within a sample and detection optics for directing light from an illuminated spot on or within a sample to the detector. Such a system may be used for determining flaws in a sample such as a thermal barrier coating on a turbine blade, or a dental or other medical part. In particular the system may be used for determining flaws in a ceramic sample. A method for detecting flaws in a sample is further described.

This invention relates to an optical measuring technique.

Manufacture of products from a material can introduce flaws. For example, if a material is machined this can introduce cracks, or if a thermal process is carried out this can introduce stress cracking from thermal gradients. It is advantageous to inspect the manufactured parts and reject any that have flaws as they are likely to fail in use. Unfortunately, for certain materials or part configurations there is no way to establish if a part has any flaws except by destroying the part. Thus there is a need for a non-destructive test method. Preferably, the method could be applied as part of an industrial process.

Yttria-Stabilized Tetragonal Zirconia Polycrystal (Y-TZP) as a high toughness, high strength and biocompatible material can be found in many medical applications where customized part manufacturing is required. Current machining techniques, including mechanical grinding and laser processing, may introduce cracking, resulting in reduced strength. Uncertainty of the exact shape, size and distribution of flaws introduced during manufacturing or machining require a reliable testing technique.

Identification of flaws in ceramic thermal barrier coatings, on turbine engine components for example, is highly desirable. In this field non-destructive methods for identifying flaws include piezospectroscopy, infra-red thermography, and reflectance imaging using a mid-wavelength infrared camera, as described by J. I Eldridge et al in their paper ‘Monitoring Delamination Progression in Thermal Barrier coatings by Mid-Infrared Reflectance Imaging’ published in the International Journal of applied Ceramic Technology, 3[2] 94-104 (2006). The mid-wavelength infrared camera imaging so described provides only two-dimensional representations of any defects and does not give any information about the depth into the material at which the defects occur. Additionally, information from this technique is limited to the resolution of the camera, and the camera is expensive.

Accordingly, the present invention provides an improved detecting system and method for detecting flaws in a material.

A first aspect of the present invention provides a detecting system for detecting flaws in a sample comprising:
an illumination assembly having an infra-red light source and illumination optics for directing a beam of light from the light source to a spot on or within a sample; and
a detection assembly having a detector for detecting light from an illuminated spot on or within a sample and detection optics for directing light from an illuminated spot on or within a sample to the detector.

Preferably, the detecting system further comprises a processor for processing the detected light. The detecting system may be an infra-red detecting system. In particular the detecting system may be a mid infra-red detecting system.

The detecting system may be provided in a housing; said housing may be attachable to a coordinate positioning apparatus, and/or an articulating head, for example.

Preferably the sample comprises a ceramic material. In particular the sample may comprise zirconia. The infra-red light source may be a mid-wavelength infra-red light source. The infra-red light source may have a wavelength of 3 to 10 μm. Preferably the infra-red light source may have a wavelength of 3 to 7 μm. More preferably, said infra-red light source may have a wavelength of 3 to 5 μm. Alternatively, or additionally, the detector may be a detector for detecting mid infra-red light. In particular the detector may be a detector for detecting mid infra-red light only.

The infra-red light source may be a spatially extended light source. The infra-red light source can be temporally incoherent. The infra-red light source can be a broad bandwidth light source.

A spatially extended light source may be at least twice the size of the light spot received by the detector. The spatially extended light source may be approximately ten times the size of the light spot received by the detector. A spatially extended light source may be greater than ten times the size of the light spot received by the detector. Preferably the light source is chosen such that illumination at the point of focus is substantially maximised and speckle contrast is substantially minimised.

A broad bandwidth light source may substantially maximise illumination and substantially minimise speckle contrast.

The illumination optics for directing a beam of light from the light source to a spot on or within a sample may comprise one or more lenses. The illumination optics may comprise one or more mirrors. The illumination optics may comprise an aperture, such as a pinhole for example; the aperture may provide a confocal illumination spot.

Directing a beam of light from the light source to a spot on or within a sample may comprise focusing the beam of light to the spot. The spot on or within the sample may be the point of focus of the illumination assembly. The illumination assembly may comprise illumination optics for directing a beam of light from the light source to a focus on or within a sample.

The illumination assembly may be arranged to maximise illumination of a chosen wavelength at the point of illumination, the illuminated spot on the sample. The illumination assembly may be arranged to minimise speckle contrast at the detector.

Detecting light from an illuminated spot on or within a sample may comprise detecting light from the focus point of the detector. The detection optics for directing light from an illuminated spot on or within a sample to the detector may be detection optics for directing light from the focus point of the detector to the detector.

The detection optics for directing light from an illuminated spot on or within a sample to a detector may comprise optics for producing a confocal light beam. Said optics may comprise an aperture, for example. Where the detection optics produce a confocal light beam, the light spot received by the detector may be a confocal light spot. The detection optics may comprise one or more lenses. The detection optics may comprise one or more mirrors.

The detector may comprise a single infra-red sensor. Alternatively, the detector may comprise multiple infra-red sensors. The output from the multiple sensors can be added together to give an overall output.

The detection assembly may be arranged to detect light which has been transmitted through a sample. Alternatively, or additionally, the detection assembly may be arranged to detect light which has been reflected or backscattered by a sample.

The illumination assembly may have an illumination optical axis. The detection assembly may have a detection optical axis. The term optical axis is well known in the art. The bisector of the illumination and detection optical axes is a vector which equally divides the illumination optical axis and the detection optical axis with the smallest angle.

Where the detection assembly is arranged to detect light which has been reflected or back scattered by a sample, preferably the bisector of the illumination and detection optical axes is not substantially parallel to the normal of the surface of the sample to be inspected.

The detection system and illumination system may be relatively moveable. In this case the illumination optics for directing a beam of light from the light source to a spot on or within a sample may be arranged to keep the spot on or within a sample substantially aligned with light detected by the detector. The light detected by the detector may be a spot; said spot may be a confocal spot. Thus, the focus of illumination of the illumination assembly may be kept substantially aligned with the confocal spot of the infra-red detector system.

The spot may be a small area of illumination relative to the sample. The spot may be the point of focus of the illumination assembly. The spot may be circular, square, or any other shape. There may be a plurality of sub-spots illuminated on the sample; said plurality of sub-spots may each be detected by a single detector, or by separate detectors. There may be a plurality of spots illuminated. Each spot or sub-spot may be produced by a single illumination source, or a plurality of illumination sources.

The detecting system may comprise a sample holder. The sample holder and illumination assembly of the detecting system may be relatively moveable. The sample holder and detection assembly of the detecting system may be relatively moveable. The sample holder may be relatively moveable with respect to both the illumination and detection assemblies of the detecting system. The sample holder may be moveable in one two or three linear degrees of freedom. The sample holder may be rotatable. For example, the sample holder may be tiltable.

The processor for processing the detected light may comprise a signal amplifier. The signal amplifier may be located within the detecting system housing. The processor for processing the detected light may comprise digitisation electronics. The digitisation electronics may be located within the detecting system housing.

The processor for processing the detected light may comprise a computer processor. The computer processor may be located in a controller for a positioning apparatus on which the detecting system may be mounted. However, it will be understood by the skilled person that the components of the processor may be located elsewhere.

The detecting system may be mounted to a positioning apparatus. The positioning apparatus may be a coordinate positioning apparatus, such as a machine tool, positioning robot, or coordinate measuring machine, for example. Such a positioning apparatus may have one, two, or preferably three linear degrees of freedom. The positioning apparatus may have other degrees of freedom, such as at least one rotational degree of freedom. The positioning apparatus may have, for example, two or three rotational degrees of freedom.

The detecting system may be mounted on an articulated head. The detecting system may be mounted on an articulated head which is in turn mounted to a positioning apparatus. The articulating head may be, for example, motorised or manual. The articulating head may be an indexing head or a continuously rotatable head. The articulating head may have at least one rotational degree of freedom. Preferably, the articulating head has at least two rotational degrees of freedom. The articulating head may have a plurality of rotational degrees of freedom.

A second aspect of the present invention provides a method for detecting flaws in a sample comprising the steps of:
directing a beam of light from a source of infra-red light to a spot on or within a sample;
detecting light from the illuminated spot on or within the sample; and
analysing the light from the sample to identify any flaws.

Preferably the method is carried out using the detecting system as described hereinbefore. The steps of directing a beam of light from a source of infra-red light to a spot on or within a sample, and detecting light from the illuminated spot on or within the sample may be carried out by a detecting system mounted on a coordinate positioning apparatus. The step of detecting light from the illuminated spot on or within the sample may be carried out by a detector having a point of focus.

The method may comprise the additional steps of
scanning the point of focus of the detector across or through the sample; and
detecting light from the sample as the point of focus of the detector is scanned across or through the sample.

Said method may also comprise the step of
moving the illuminated spot across or through the sample.

The focal point of the detecting system may be moved across or through the sample synchronously with the illuminated spot.

Where the sample, or sample holder, is relatively moveable with respect to the illumination assembly, detection assembly, or both, the method may comprise the additional step of scanning the sample. Scanning the sample may comprise relatively moving the spot of light and the sample. Relatively moving the spot of light and the sample may comprise relatively moving the beam of light directed from a source of infra-red light to a spot on or within a sample and the sample. Moving the beam of light directed from a source of infra-red light to a spot on or within a sample may comprise moving the light source or illumination optics, or both.

An X or X,Y or X,Y,Z motion stage, onto which a sample or the detection and/or illumination assemblies may be placed, may be provided to achieve said relative movement. A motion stage having other degrees of freedom, such as rotational degrees of freedom may be provided. Advantageously the motion stage has three translational degrees of freedom and two rotational degrees of freedom; however other may be desirable depending on the application. Relative movement between the sample and the detection system may be achieved by mounting the detection system on a positioning machine such as a coordinate positioning machine. In particular, relative movement between the sample and the detection system may be achieved by mounting the detection system on an articulating head, which is in turn mounted on a coordinate positioning machine. The sample may be mounted, for example, to the bed of the coordinate positioning machine.

The method may comprise collecting data from a plurality of illuminated spots on or within a sample. Data detected from each illuminated spot on or within the sample during the scan may be accumulated. In such a way a map of the amount of light transmitted, reflected, scattered or absorbed by parts of a sample may be built up.

Line data may be obtained, for example by performing a one dimensional scan of the sample. Plane data may be obtained by performing a two dimensional scan. Volume data may be obtained by performing a three dimensional scan of the sample; in this case the light spot may be moved through the volume of the sample.

The method may comprise a calibration step. The calibration step may comprise determining the relationship between the position of the light detected from the illuminated spot on or within the sample and the coordinate system of the coordinate positioning apparatus. The light detected from the illuminated spot on or within the sample may be the light detected from the focal point of the detector.

The method may comprise a further step of inspecting the sample with a first inspection system to obtain data from the sample.

The step of inspecting the sample with a first inspection system to obtain data from the sample may be carried out by the first inspection system mounted on a coordinate positioning apparatus.

The method may further comprise a calibration step of determining the relationship between the position of the light detected from the illuminated spot on or within the sample and the data obtained from the sample with the first inspection system.

The position of the light detected from the illuminated spot on or within the sample is the position on the sample from which the detector detects light, in other words the focus point of the detection system.

The calibration step of determining the relationship between the position of the light detected from the illuminated spot on or within the sample and the data obtained from the sample with the first inspection system may comprise the steps of:
determining the position of a first point of a calibration artefact using the first inspection system;
determining the position of said first point of the calibration artefact using the detecting system; and
determining the offset between the positions of the first point.

A calibration artefact may be provided. Said calibration artefact may be, for example, a datum sphere. Other calibration artefacts are known and are appropriate for use with the detecting system; one example of such a calibration artefact is the corner of a cube. The calibration artefact may comprise zirconia. The calibration artefact may have a known form which may be measured by both a first inspection system, such as a touch trigger, scanning, or surface finish probe, and the detecting system according to the present invention. The calibration artefact may have a geometric feature locatable in three dimensions by both a first inspection system and the detecting system according to the present invention. The first inspection system and the detecting system may have the same coordinate frame of reference. The calibration artefact may be mounted on the bed of a coordinate positioning apparatus.

Preferably the detecting system is the detecting system according to the present invention. Where the calibration artefact is a sphere, the first point of the calibration artefact may be the centre of the sphere. Where the calibration artefact is a cube, the first point may be a first corner of the cube.

The method may further comprise the step of applying the offset determined during the calibration step to data acquired by the detecting system.

The invention also provides a computer program code comprising instructions which, when executed by a processing device for example within a computer or a controller, causes the processing device to perform the methods previously described. In addition the invention provides a computer readable medium, bearing computer program code comprising instructions which, when executed by a processing device, causes the processing device to perform the methods previously described.

In a further embodiment, the invention provides a processing device comprising:
a processor; and
a memory, wherein at least one of the processor and the memory is adapted to perform the methods previously described.

A processing device can be located in a computer or a controller which are temporarily or permanently attached to the detecting system. The computer can be a stand alone unit, integrated within a detector system or connected to a detecting device.

Also described is a method for detecting flaws in a sample comprising the steps of:
directing light from a source of infra-red light onto a sample;
detecting light from the sample;
analysing the light from the sample to identify any flaws.

Further described is a detecting system for detecting flaws in a material. Preferably the material is a ceramic, and in particular zirconia.

The detecting system may comprise:
an infra-red light source;
emitting optics for directing light from the light source onto a sample;
detecting optics for directing light from a sample to a detector;
   a detector for detecting light from a sample; and
   a processor for processing the detected light.

Ceramic materials have unique optical properties, with respect to absorption and scattering, which make the development of a rapid and robust optical measuring technique difficult. The scattering of visible light is particularly problematic for these opaque ceramics. Mid-infrared (MIR) measuring technique is an imaging method using optical transmission through the sample, reflection by the sample, or absorption by the sample, such transmission, reflection and absorption is possible due to the reduced scattering that occurs at these wavelengths. The light from a broadband infrared source illuminates the sample which is observed by an infrared sensor. When optical transmission through a sample is observed dark regions appearing in images indicate the presence of features, such as cracks or other flaws, within the bulk material.

Optical inspection of ceramics can be hampered by the large amount of scattering which occurs in these semi-opaque materials. This can be overcome by the use of light which has a wavelength similar to the dimensions of the crystals in the structure. In the case of dental zirconia and thermal barrier coatings this is of the order of 1 to 10 μm. Zirconia's optical transmission characteristics are such that the longer wavelengths in this range are absorbed, and the shorter wavelengths are scattered to a greater extent. There is therefore an optical “window” around 3 to 5 μm where light is transmitted, and allows for inspection of features buried several millimetres below the surface. Wavelengths of approximately 3 to 7 μm can be used; however the range of 3 to 5 μm is preferred as this has been found to produce the best results for this material.

In one example a scanning confocal microscope arrangement is used, either in transmission or reflection, operated at micron order wavelength infra-red light. A beam from the infra red light source is directed onto the sample and a camera or other sensor receives the resultant beam which is then analysed.

The invention will now be described by way of example, with reference to the accompanying drawings, of which:

FIG. 1 shows a transmissive infra-red camera imaging system;

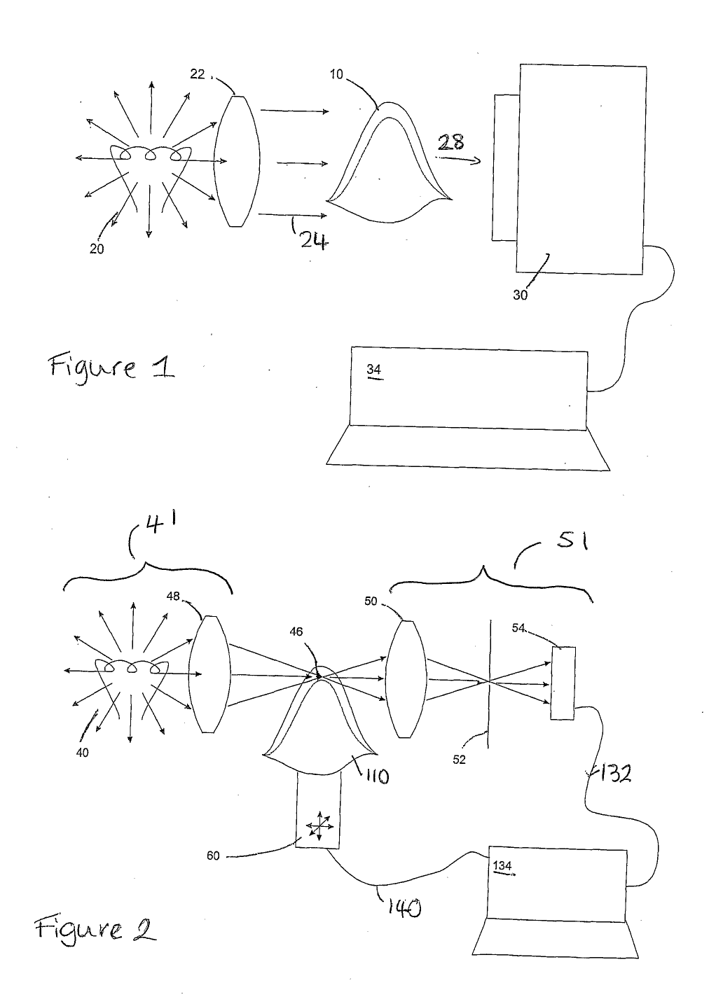

FIG. 2 shows an example of a transmissive infra-red spot detection system;

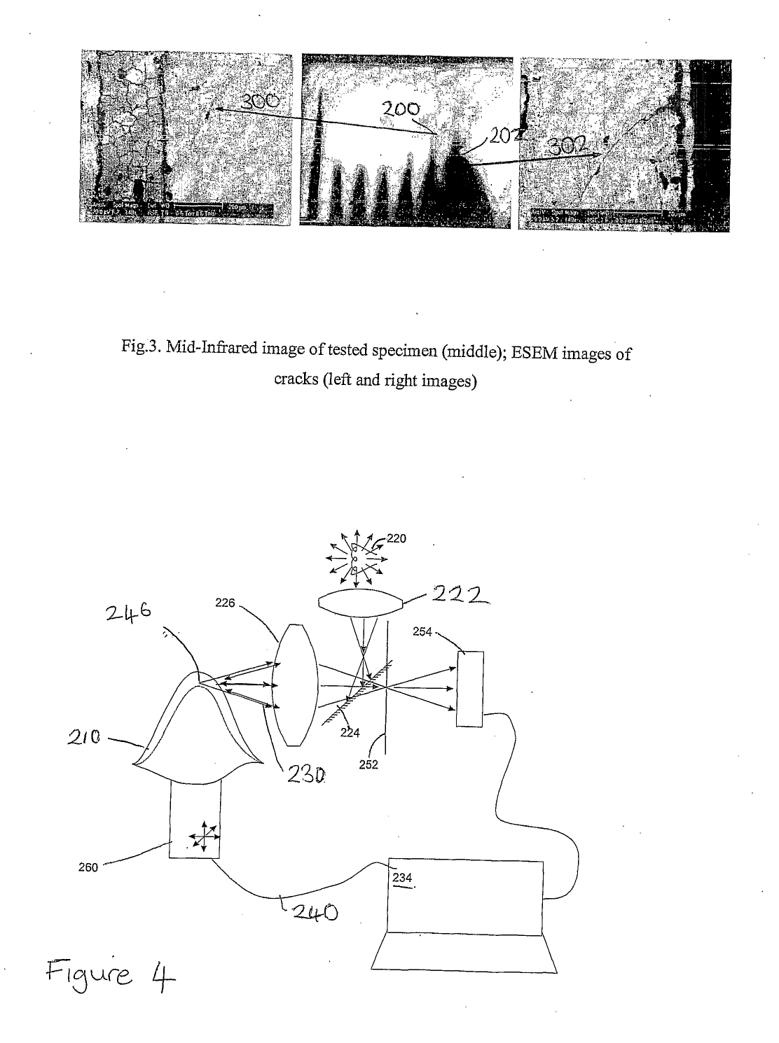

FIG. 3 shows an MIR image and subsequent ESEM images taken of a sample of zirconia;

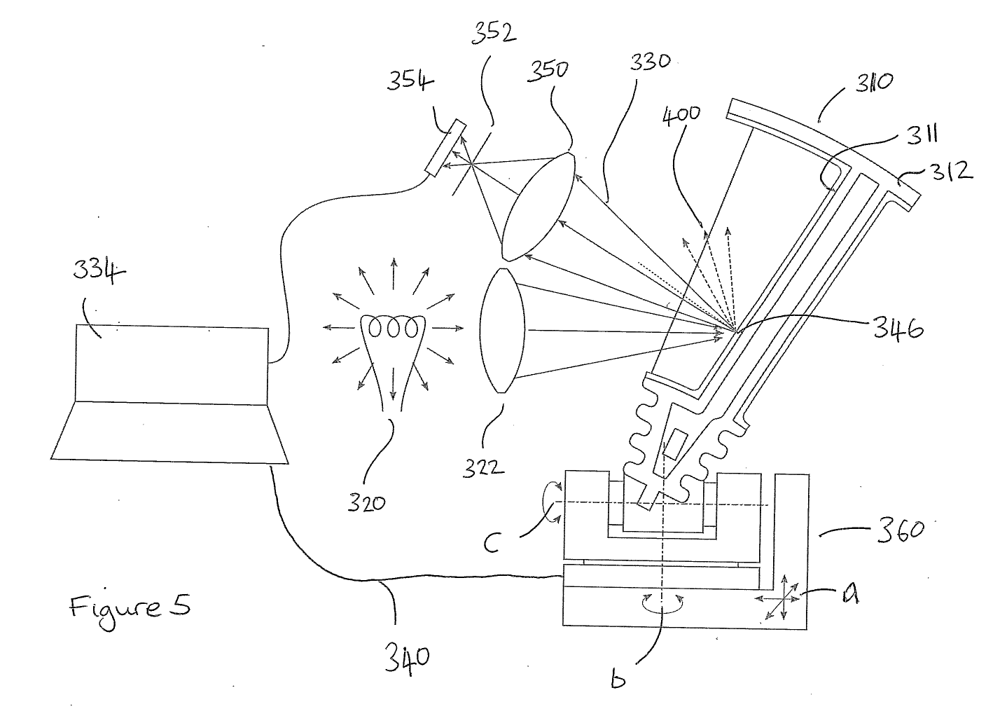

FIG. 4 shows an example of a reflective detection system;

FIG. 5 shows an example of an off-axis reflective detection system;

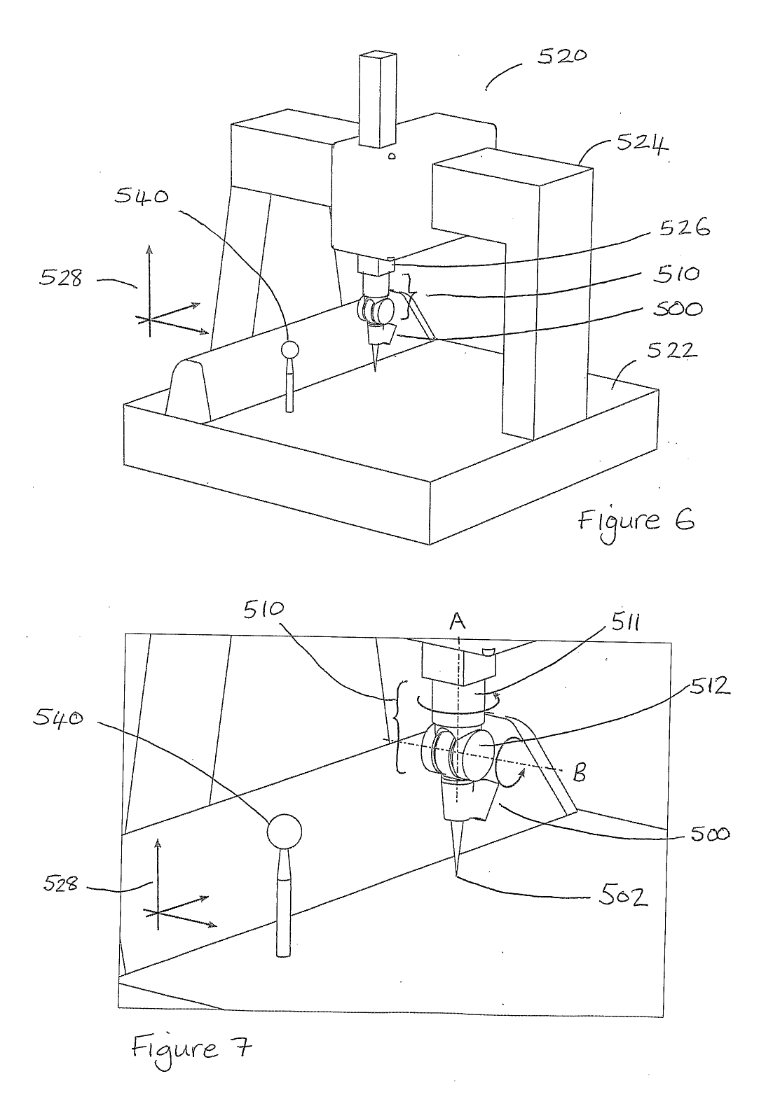

FIG. 6 shows an example of an infra-red imaging system mounted on an articulating head which is in turn mounted on a coordinate positioning apparatus; and

FIG. 7 shows a close-up view of the infra-red imaging system and articulating head shown in FIG. 6.

FIG. 1 shows a transmissive infra-red imaging system. A sample 10 is illuminated by an infra-red light source 20, for example a filament lamp, and radiation 28 which passes through the sample 10 is examined by means of an infra-red sensitive camera 30.

Light from an infra-red source 20 is passed through collimating optics 22 to produce a collimated beam 24 which is incident on the sample 10 under inspection. Radiation 28 which passes through the sample 10 is received by an infra-red camera 30. The data 32 from the camera is processed using, for example, image processing software 34 to produce an image of the sample (as shown in FIG. 3).

The image of the sample obtained from the transmissive infra-red camera imaging system will provide information on the transmission properties of the sample 10 near the focal plane of the camera 30. The infra-red camera imaging system of FIG. 1 has some disadvantages which may limit its field of use, for example it provides only two-dimensional information; the information is limited to the resolution of the camera; and the camera is expensive.

FIG. 2 shows a transmissive infra-red detection system comprising an illumination assembly 41 having a light source 40 and first focusing optics 48 for focussing the light source to a spot 46, and a detector assembly 51 having a focussing lens 50, aperture 52 and an infra-red sensitive detector 54. A sample 110, mounted on a motion stage 60, is positioned between the illumination assembly 41 and the detector assembly 51. Data from the infra-red detector 54 is sent 132 to a processor 134.

In the detection system shown in FIG. 2 a broad area of infra-red illumination (as used in the apparatus of FIG. 1) is not needed. Instead, the light from a source 40 is focussed using first focusing optics 48 to a spot 46 on or within the sample 110; this improves the efficiency of the light source by increasing the illuminance at the spot for a given power light source. A focussing lens 50, aperture 52 and single infra-red sensitive detector 54 are used to detect light transmitted from the sample 110. The aperture 52 is at the conjugate point of the detector focussing optics 50 and serves to reject light out of the focal plane of the optics—i.e. it ensures light from only one depth is transmitted to the detector 54, thus the detection system is confocal. Use of a single infra-red sensitive detector 54 is cheaper than use of a number of infra-red sensors.

The light source 40 shown in FIG. 2 is a filament lamp. This light source is broad bandwidth, spatially extended and temporally incoherent. Illumination of the sample is not confocal. All these factors enable the imaging system to have a low speckle contrast.

The use of such a light source places further requirements on the design of the imaging system. Firstly, because the source is of broader bandwidth, in order that the confocal imaging system has a consistent focal length (and hence focuses on a point a consistent distance from the objective lens) the imaging optics should be effectively achromatic over the optical bandwidth of the combined source and detector arrangement. The use of a spatially extended source increases the size of the minimum focal spot of the illumination, thereby reducing the irradiance at the point where the confocal imaging system is focused. Also contributing to a reduction in irradiance at this focal point is the fact that temporally incoherent sources tend to be of lower power than temporally coherent ones, i.e. laser sources. It is therefore important that as much light as possible from this lower intensity source reaches the focal point of the confocal system, and that as much transmitted light can reach the detector. A wavelength of light that has good transmission characteristics through the ceramic under inspection is therefore desirable.

Thermal barrier coatings, ceramic medical implants (for example dental restorations, replacement joints, synthetic bone implants etc) and other structural ceramic parts are typically constructed from Zirconia or similar ceramics. Such ceramics require a wavelength in the mid wavelength infra-red region of 3-8 μm (Byrnes, James (2009). “Unexploded Ordnance Detection and Mitigation.” Springer. pp. 21-22. ISBN 9781402092527) with wavelengths of 3-5 μm being preferred.

The illumination 41 (40, 48) and detector 51 (50, 52, 54) assembly (also known as an emitter-detector assembly 41,51) shown in FIG. 2 are in a fixed spatial relationship to each other. A map of the amount of light transmitted by parts of the sample 110 can be built up by moving the sample 110 in relation to the emitter-detector assembly 41,51 scanning the areas of interest of the part through the focal point of the detector assembly. One way of moving the sample 110 with respect to the emitter-detector 41,51 is to provide an X,Y or X,Y,Z (as shown) motion stage 60 onto which the sample 110 is placed. Alternatively, the emitter-detector assembly 41, 51 may be moved with respect to the sample, or the emitter and detector may be moveable relative to one another. Where the emitter and detector are relatively moveable the focus of illumination of the emitter system should be kept substantially aligned with the confocal spot of the infra-red detector system. Such relative movement can overcome shadowing of parts and minimise the material through which the illuminating and return signal have to pass.

The spatial resolving power of the system can be improved by spatially over-sampling the transmission response and deconvolving the result with the point spread function of the detector system. This leads to a high resolution, 3D, non-destructive inspection system for the inspection of ceramics.

The data from the infra-red detector 54 shown in FIG. 2 is sent 132 to a processor 134. Advantageously, the processor 134 also sends movement instructions 140 to a motion stage 60, on which the sample 110 is mounted. This makes it easier to process data from the sensor into an image of the sample as the processor has both coordinate information relating to the position of the sample 110, and to the data received by the infra-red detector 54.

The assembly of FIG. 2 is considerably less expensive and more sensitive than the infra-red camera system shown in FIG. 1. By moving the sample 110 in relation to the emitter-detector 41,51 not only can a 2D transmission response for the sample be prepared, but because the aperture rejects light out of the focal plane, depth information can also be retrieved. Thus a 3D map of the sample can be produced.

The location of the optics and the focal length of the optics in the system are known, so the position of the point of focus can be determined. Additionally, in a confocal system the light received by the detector comes from the plane in which the point of focus lies, as all other light is rejected by pinhole. Therefore, the infra-red detection system can determine from which point in the sample each piece of information came, and the 3D map can be produced.

Other light sources which may be used in the embodiment of FIG. 2 include florescent lamps, and Xenon flash lamps. Such lamps give low speckle contrast.

In an alternative embodiment the light source may be, for example, a laser light source. The laser, or other light source may be fibre launched. By fibre launching light, the spatial extent of the light source is defined by the core diameter of the fibre. Single mode fibre optics have small core diameter, for example less than 10 microns; therefore, the spatial extent of light source is of order of less than 10 microns.

Compared to a filament lamp, for example, laser light and fibre launched light give increased illuminance at the point of interest in the sample. Such light sources may be used where deeper penetration of the sample is required. The laser light source or fibre launched light source may be confocal to achieve deeper penetration of the sample. However, such light sources can produce high contrast speckle which in turn superimposes fixed pattern random noise over any resultant data. Such fixed pattern random noise must be filtered; however, the action of the filter can not distinguish between the noise and signal (such as fine cracks or voids) so features of the same order of scale as the speckle noise are also filtered. The ability to resolve small features are significantly compromised by use of a high contrast speckle producing light source.

The sample presented in FIG. 3 contains laser machined holes, and between these holes cracks have developed due to the high thermal gradients occurring during the laser process. These cracks 200, 202 are apparent in the MIR image. To confirm the existence of the cracks, ESEM images of the sample were made after sectioning the samples and the cracks detected can be seen at 300 and 302 respectively.

Due to the favourable optical properties of the ceramic (in terms of scattering and absorption at MIR wavelengths) there is both sufficient light transmission and contrast change in the regions where flaws occur for crack detection on the micro-scale (in the order of single microns), even in material up to 6 mm thick. Previously, it has only been possible to detect flaws in ceramics of these thicknesses using destructive techniques (i.e. sectioning) which is not appropriate for final part inspection. Consequently, this Mid-Infrared Transmission Imaging (MIR-TI) technique offers a novel, reliable solution for inspection of thick sections of Zirconia material.

FIG. 4 shows a reflective detector system. In this example, light from an infra-red source 220 is passed through first focusing optics 222 onto a beam splitter 224. Light from the beam splitter is focused into a spot 246 on the sample 210 using second focusing optics 226. Light reflected or backscattered 230 from the sample 210, passes back through the second focusing optics 226 and through the beam splitter 224 through an aperture 252 and onto an infra-red sensor 254. Data from the sensor 254 is processed in a processor 234.

If the sample is mounted on a movable stage 260, as shown in FIG. 4, then it is preferred that the instruction 240 relating to this movement are given to the motors of the stage (not shown) by the processor 234.

In the reflective system shown in FIG. 4 an imperfection produces back scattering of the light, so unflawed material gives a dark response at the detector and an imperfection or flaw gives a light response. In effect the reflective system gives a negative image to that received for a transmissive system.

In an alternate reflective arrangement a mirror is placed behind the sample and is suitable for use in assessing ceramic coatings on turbine blades. However, in some systems a mirror may confuse the signal detected, the detector may receive light reflected from the mirror and backscattered from any flaws in the material. Thermal barrier coatings may be inspected, without a mirror behind, with a reflective system as described with reference to FIGS. 4 and 5.

FIG. 5 shows an example of an off-axis reflective infra-red detection system. In this example, light from an infra-red source 320 is focussed to a spot 346 on or within the sample 310 by first focusing optics 322. Light reflected or backscattered 330 from the spot 346 on or within the sample 310, passes through second focusing optics 350, through an aperture 352 and onto an infra-red sensor 354. Data from the sensor 354 is processed in a processor 334.

In this example, the sample 310 comprises a thermal barrier coating 311 on a turbine blade 312. The sample 310 is mounted on a movable and tiltable stage 360. The stage 360 can move in x, y, z and in two rotational axes, as indicated by the arrows a,b,c shown. Again, it is preferred that the instruction 340 relating to this movement are given to the motors of the stage (not shown) by the processor 334.

The stage 360 is a motion system which can move the sample 310 to ensure that the surface of the sample 310 under inspection is not substantially normal to the bisector of the optical axes of illumination and imaging systems. This reduces the chance of specularly reflected light 400 reaching the sensor 354 and masking the light reflected from the spot 346 on or within the sample 310.

Where the sample 310 is complex, positioning the sample 310 such that the surface of the sample 310 under inspection is not substantially normal to the bisector of the optical axes of illumination and imaging systems may cause difficulties with shadowing, and a coaxial system may be preferred. If the reflective system is not ‘off-axis’ a polarising filter may be provided in the system in order to remove the possibility of specularly reflected light 400 from the surface masking the back scattered light. However, whilst such filters may avoid the problem of specular reflection reaching the detector, half of the signal is also discarded. Where the irradiance is low, in the case of the embodiment which minimises speckle, it may be disadvantage to discard half of the signal.

In a coaxial system the signal strength of an off-axis system may be maintained by halving the rate at which measurements are taken for the coaxial system. Alternatively an imaging system with a higher numerical aperture may be used, which effectively is able to collect more of the back scattered light. This is expensive and bulky and may restrict access, but has the advantage that it further reduces speckle contrast, and enhances the depth resolution capability of system. In a practical system a compromise has to be reached over whether a coaxial system is required, and what size of numerical aperture is appropriate based on cost, speed, access and resolution, the correct balance of these factors being application dependant.

The use of a confocal imaging system as described with reference to FIGS. 2, 4 and 5 can localise the depth at which the optical phenomena, such as scattering, transmission, reflection and absorption, are observed. In order to produce data relating to the sample the point of focus must be scanned through the volume of interest. For line data a one dimensional scan is adequate, for plane data a two dimensional scan is required, and for volume data a three dimensional scan is required. This scanning, in addition to the requirement to measure conformal coatings on parts with complex forms—for example high pressure turbine blades—can be time consuming. It can therefore be advantageous to mount the imaging system on a coordinate positioning machine, as described with reference to FIG. 6.

FIG. 6 shows an example of an infra-red inspection system 500 mounted on an articulating head 510 which is in turn mounted on a positioning apparatus, in this case a coordinate measuring machine 520; FIG. 7 shows a close-up view of the infra-red inspection system 500 mounted on the articulating head 510. A calibration artefact 540 is also shown.

The coordinate measuring machine 520 comprises a machine bed 522 and a relatively moveable carriage 524 which carries an arm 526. The arm 526 of the machine is moveable in three linear axes, x, y, and z, as shown by arrows 528. The articulating head 510 is attached to the arm 526 of the coordinate measuring machine 520 for movement therewith.

The articulating head 510 is rotatable about first and second axes, A and B respectively. The articulating head 510 comprises first and second housing members 511 and 512 respectively. The first housing member 511 is adapted for attachment to the arm 526 of the coordinate measuring machine 520, and houses a first motor (not shown) for effecting angular displacement of a first shaft (not shown) about the first axis A. Attached to the first shaft is the second housing member 512, which houses a second motor (not shown) for effecting angular displacement of a second shaft (not shown) about the second axis B. The infra-red inspection system 500 is attached to the second shaft, for rotation therewith. An articulating head for use on a coordinate measuring machine is described more fully in Renishaw's patent application number WO2006/114570.

The linear axes of the coordinate positioning machine allow the scanning of the spot focus of the infra-red inspection system 500 through the ceramic volume of interest. The addition of rotary axes by use of an articulating head allows access to parts of the volume where line of sight may be difficult and can avoid problems with shadowing where the optical axes of the illumination and imaging systems of the infra-red inspection system are not coincident. The rotary axes may allow the infra-red inspection system to avoid an attitude to the surface which would introduce specular reflection back into the detector of the infra-red inspection system (i.e. ensure that the normal of the surface is not parallel to the bisector of the illumination and detection optical axes).

The infra-red inspection system 500 is a reflective infra-red detection system, as described with reference to FIGS. 4 and 5. Light from the illumination assembly of the infra-red inspection system 500 is brought to a point of focus 502; when inspecting an object said point of focus 502 will be positioned to be at a desired point on the surface of, or within the bulk material of, the object.

The infra-red inspection system 500 is mounted to the articulating head 510 in place of, for example, a measurement probe. During an operation on an object the infra-red inspection system 500 may be exchanged for a different type of inspection system, such as a scanning, touch trigger measurement probe, or surface finish probe. The exchange may take place, for example, by hand, or by operating the coordinate measuring machine to move the articulating head to an inspection system rack, where other inspection systems are stored, and operating the machine to exchange the infra-red inspection system 500 for another inspection system held in the inspection system rack. Thus an imaging operation, using the infra-red inspection system 500 may be carried out before, after, or during other inspection operations.

A calibration artefact, in the form of a zirconia datum sphere 540, is mounted on the bed 522 of the coordinate measuring machine 520. A calibration process may be carried out, using the zirconia datum sphere 540 to establish the relationship between the point of focus 502 of the infra-red inspection system 500 and the coordinate system of the coordinate measuring machine 520.

The zirconia datum sphere 540 has a known form which may be measured by both a first inspection system (described hereinbefore) and the infra-red inspection system 500. The position of the centre of the datum sphere 540 is located by the first inspection system, then the infra-red inspection system (or vice versa); the offset between the two centres is used to establish where the point of focus 502 of the infra-red inspection system 500 is relative to the measuring centre of the first inspection system. This offset can then be applied to any further data acquired such that coordinate geometry, and other data established by other inspection systems mounted on the coordinate positioning apparatus, can be related to data concerning defects within the ceramic components established by the infra-red inspection system 500.

Instead of a zirconia datum sphere any other datum artefact whereby a single point can be uniquely established using both a first inspection system and the infra-red inspection imaging system may be used.

When inspection of a sample by a system other than the infra-red inspection system is carried out on the same coordinate positioning apparatus, geometry and/or other data relating to the sample are essentially in the same coordinate frame of reference as the infra-red imaging system data. This allows sophisticated process development in that, for example, surface finish at known positions relative to a part coordinate system may be accurately assessed before a thermal barrier coating is applied, and the effect of this surface finish on thermal barrier coating growth or defects may be established by inspecting the part in the same part coordinate system after the coating process. This allows much more systematic and accurate process development and control. Correlation of automatic inspection data in aerospace and medical fields also provides a robust and automatic quality control and record keeping capability, with more limited scope for human error. This is desirable for aviation and medical certification authority approvals.

Although a coordinate measuring machine is described, other positioning apparatus such as a machine tool, or robot arm for example. A system comprising a positioning apparatus and an articulating head, as described hereinbefore, may be described as a positioning robot. In particular, a system comprising a coordinate positioning apparatus and an articulating head may be described as a coordinate positioning robot.

The articulating head described may be, for example, motorised or manual. The articulating head may be an indexing head or a continuously rotatable head.

Furthermore, the infra-red inspection system 500 itself may be attached to a positioning apparatus for movement therewith, rather than being attached to an articulating head or other intermediate device attached to the positioning apparatus.

The sample shown in FIGS. 1, 2, and 4 is a ceramic dental component. Identification of flaws in ceramic components in the dental and many other industries is essential. Non-destructive tests in the dental field are restricted to “candling”—shining a bright light through the object and looking for shadows or imperfections, dye penetration and X-ray. All but dye penetration have low resolution and can only identify the largest cracks, and dye penetration is inappropriate for cosmetic parts and has issues with toxicity. Small cracks which can not be identified by X-ray or candling can have a significant detrimental effect on the mechanical integrity of a part.

Accordingly, the present invention may provide a method for detecting flaws by use of non-destructive testing of ceramic materials and in particular for zirconia materials using a mid-infrared transmission or reflection technique. This invention allows much smaller imperfections, buried up to several millimetres inside a ceramic part, to be identified, including cracks much smaller than those on the limit of what can be achieved by existing techniques.

Although the examples and specific description relate to Zirconia material and its use in particular in the dental industry, the methods and detection systems described are applicable to other ceramic materials and to other industries where either flawless parts or only very minor flaws can be tolerated. For example, as shown in FIG. 5, the infra-red inspection system can be used to examine thermal barrier coatings.

If different materials are used then the range of wavelengths used may differ from those given in the description however, a person skilled in the art would be able to establish the optimal wavelength range by analysis of the infra-red spectrum of the material in question.

An easy way to show the results of the inspection of a sample is to use an image; however the information could be presented differently, for example in a table.

1. A detecting system for detecting flaws in a sample comprising:
an illumination assembly having an infra-red light source and illumination optics for directing a beam of light from the light source to a spot on or within a sample; and
a detection assembly having a detector for detecting infrared light and detection optics for directing light from an illuminated spot on or within a sample to the detector.

2. A detecting system according to claim 1 for detecting flaws in ceramic material.

3. A detecting system according to claim 1 for detecting flaws in zirconia.

4. A detecting system according to claim 1, wherein the infra-red light source is a mid-wavelength infra-red light source.

5. A detecting system according to claim 4, wherein the infra-red light source has a wavelength of 3-7 μm.

6. A detecting system according to claim 5, wherein the infra-red light source has a wavelength of 3-5 μm.

7. A detecting system according to claim 1, wherein the infra-red light source is spatially extended.

8. A detecting system according to claim 1, wherein the infra-red light source is temporally incoherent.

9. A detecting system according to claim 1, wherein the light source is a broad bandwidth light source.

10. A detecting system according to claim 1 wherein the detection optics for directing light from an illuminated spot on or within a sample to a detector comprise an aperture for producing a confocal light beam.

11. A detecting system according to claim 1, wherein the detection assembly is arranged to detect light which has been transmitted through a sample.

12. A detecting system according to claim 1, wherein the detection assembly is arranged to detect light which has been reflected or backscattered by a sample.

13. A detecting system according to claim 12, wherein the illumination assembly has an illumination optical axis and the detection assembly has a detection optical axis, and wherein the bisector of the illumination and detection optical axes is not substantially parallel to the normal of a surface to be inspected.

14. A detecting system according to claim 1, the detecting system being mounted on an articulated head.

15. A detecting system and articulated head according to claim 14, wherein the articulated head is mounted on a coordinate positioning machine.

16. A detecting system according to claim 1, further comprising a sample holder, wherein the sample holder is relatively moveable with respect to the detection and illumination assemblies.

17. A detecting system according to claim 1, further comprising a processor for processing the detected light.

18. A method for detecting flaws in a sample comprising the steps of:
directing a beam of light from a source of infra-red light to a spot on or within a sample;
detecting light from the illuminated spot on or within the sample; and
analysing the light from the sample to identify any flaws.

19. A method according to claim 18 wherein the steps of directing a beam of light from a source of infra-red light to a spot on or within a sample, and detecting light from the illuminated spot on or within the sample are carried out by a detecting system mounted on a coordinate positioning apparatus.

20. A method according to claim 19 further comprising a calibration step of determining the relationship between the position of the light detected from the illuminated spot on or within the sample and the coordinate system of the coordinate positioning apparatus.

21. A method according to claim 19 comprising a further step of inspecting the sample with a first inspection system to obtain data from the sample.

22. A method according to claim 21 wherein the step of inspecting the sample with a first inspection system to obtain data from the sample is carried out by the first inspection system mounted on the coordinate positioning apparatus

23. A method according to claim 21 further comprising a calibration step of determining the relationship between the position of the light detected from the illuminated spot on or within the sample and the data obtained from the sample with the first inspection system.

24. A method according to claim 23 wherein the calibration step comprises the steps of:
determining the position of a first point of a calibration artefact using the first inspection system;
determining the position of said first point of the calibration artefact using the detecting system; and
determining the offset between the positions of the first point.

25. A method according to claim 18, wherein light from the illuminated spot on or within the sample is detected by a detector having a point of focus, the method comprising the additional steps of:
scanning the point of focus of the detector across or through the sample; and
detecting light from the sample as the point of focus of the detector is scanned across or through the sample.

26. A method according to claim 25 comprising the additional step of: moving the illuminated spot across or through the sample.

27. A method according to claim 26 wherein the focal point of the detector is moved across or through the sample synchronously with the illuminated spot.

28. A method according to claim 18 comprising the step of:
taking a sample, wherein the sample is ceramic.
